(19) United States
(12) Patent Application Publication
(10) Pub. No.: US 2025/0250962 A1
(43) Pub. Date: Aug. 7, 2025

(54) Traffic-Driven Wind Generator Device

(71) Applicant: Roger Ward, JR., Euclid, OH (US)

(72) Inventor: Roger Ward, JR., Euclid, OH (US)

(21) Appl. No.: 18/677,955

(22) Filed: May 30, 2024

Related U.S. Application Data
(60) Provisional application No. 63/548,947, filed on Feb. 2, 2024.

(51) Int. Cl. F03D 9/46; F03D 9/25; H02K 7/18; H02K 11/00; H05B 3/28

(52) U.S. Cl. CPC F03D 9/46; F03D 9/25; H02K 7/183; H02K 11/0094; H05B 3/28; F05B 2220/706; F05B 2240/9113

(57) ABSTRACT

A traffic-driven wind generator device is disclosed that captures, harnesses, and redirects wind speed from vehicles on highways to power cylindrical and spherical underground megawatt electrical generators. The traffic-driven wind generator device comprises a body component that is configured as an upright cylinder with paddles on the outside that will catch the wind from vehicles passing by. The body component can be embedded within the infrastructure of tunnels to rotate the wind turbines and generate renewable energy. The device may vary in design while providing users with generated electricity.

### CROSS-REFERENCE TO RELATED APPLICATION

The present application claims priority to, and the benefit of, U.S. Provisional Application No. 63/548,947, which was filed on Feb. 2, 2024, and is incorporated herein by reference in its entirety.

### FIELD OF THE INVENTION

The present invention relates generally to the field of traffic-driven wind generator devices. More specifically, the present invention relates to an electrical power generation device for capturing, harnessing, and redirecting wind speed on automobiles to power underground megawatt electric generators. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in traffic-driven wind generator devices. Generally, roadway tunnels are commonly equipped with lights to maintain visibility through the tunnel. However, these lights may go out if there is no electricity supplying power to the lights. Further, snow and ice can be difficult to treat inside a tunnel. Additionally, renewable energy is important for reducing the consumption of fossil fuels.

One form of alternative energy production is wind generators, which are sometimes referred to as wind turbines. Wind generators may be categorized into two general types: those with a horizontal turning shaft that point into the wind, or those with a vertical shaft that point vertically (or upward). The blades or vanes provided on the horizontal shaft are lifted aerodynamically as the wind blows into the device, causing the shaft to turn. Alternately, the vertical shaft generally comprises two vanes that catch the wind, thus causing the vertical shaft to turn.

Furthermore, bridges, tunnels, and other structures need lighting for safety purposes as well as road signs and road warning signs, all need lighting. In remote areas such lighting is often not possible due to where they are situated. Florescent paint and other reflective devices are often used which mostly prove inadequate. Additionally, adverse weather, such as snow and ice can collect inside and around the tunnels, making it difficult to drive.

Accordingly, there is a demand for an improved traffic-driven wind generator device that captures, harnesses, and redirects wind speed from vehicles to power electric generators. More particularly, there is a demand for a traffic-driven wind generator device that generates power for tunnel lights and underground heating systems.

Therefore, there exists a long-felt need in the art for a traffic-driven wind generator device that provides users with an electrical power generator device for capturing, harnessing, and redirecting wind speed on automobiles to power underground megawatt electric generators. There is also a long-felt need in the art for a traffic-driven wind generator device that features cylinders installed within the tunnel that house the wind turbines. Further, there is a long-felt need in the art for a traffic-driven wind generator device that allows the wind turbines to rotate and generate power as vehicles pass through the tunnel. Moreover, there is a long-felt need in the art for a device that includes tunnel lights and underground heating systems that can melt snow and ice on the road when powered via the turbines. Further, there is a long-felt need in the art for a traffic-driven wind generator device that offers a way to generate renewable electricity to reduce the consumption of fossil fuels. Finally, there is a long-felt need in the art for a traffic-driven wind generator device that can replace power sources for cities in emergencies, replacing windmills.

The subject matter disclosed and claimed herein, in one embodiment thereof, comprises a traffic-driven wind generator device. The device captures, harnesses, and redirects wind speed from vehicles on highways to power cylindrical and spherical underground megawatt electrical generators. The traffic-driven wind generator device comprises a body component that is configured as an upright cylinder with paddles on the outside that will catch the wind from vehicles passing by. The body component can be embedded within the infrastructure of tunnels to rotate the wind turbines and generate renewable energy. The device may vary in design while providing users with generated electricity. The device can be used to charge vehicle batteries by providing a specialized battery that allows the vehicle to replace the vehicle's battery cells with the recharged chemicals used in batteries. The device can also replace power sources for cities in emergencies, replacing windmills to offer a more efficient and consistent power source. The ability of the device could potentially be harnessed to supply several surrounding neighborhoods with electricity that could be stored in several megawatt generators, as needed.

In this manner, the traffic-driving wind generator device of the present invention accomplishes all of the foregoing objectives and provides users with a device that captures, harnesses, and redirects wind speed from vehicles to power generators. The device is an upright cylinder with paddles on the outside that will catch the wind from vehicles passing by. The device can be positioned in or near tunnels.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a traffic-driven wind generator device. The device captures, harnesses, and redirects wind speed from vehicles on highways to power electrical generators. The traffic-driven wind generator device comprises a body component that is configured as an upright cylinder with paddles on the outside that will catch the wind from vehicles passing by. The body component can be embedded within the infrastructure of tunnels to rotate the wind turbines and generate renewable energy. The device may vary in design while providing users with generated electricity.

In one embodiment, the traffic-driven wind generator device is a wind-capturing, harnessing, and redirecting electrical generator device comprising a plurality of generators that are driven by wind created by traffic passing at high speeds through a tunnel or other roadway structure. The device uses horizontally or vertically-mounted paddles to capture the wind and produce electrical energy. Accordingly, a plurality of traffic-driven wind generator devices may be mounted in close proximity to vehicular passageways (i.e., highway overpasses, tunnels, and/or train rails, etc.) to drive an electrical power generator to generate power. The traffic-driven wind generator device can also be used with a train system, such as a high-speed train system, including “bullet” or MAGLEV trains, which provide a high-speed buffeting force.

In one embodiment, the traffic-driven wind generator device comprises a vertically-mounted wind generator. Specifically, the device comprises a body component that is configured as an upright cylinder with a plurality of paddles on the outside that act to catch wind from vehicles driving past. The body component can be any suitable size and shape as is known in the art. Any suitable number of paddles can be utilized within each body component. The paddles can be any suitable shape and size and are energy-capturing vanes. Further, the vertical configuration of the body component can be integrated within the walls of the tunnel or any other suitable position as is known in the art. Further, any suitable number of vertical body components can be positioned within the tunnel as is needed, depending on the wants and/or needs of the user.

In one embodiment, any suitable number of vanes/paddles can be utilized as is known in the art. Further, the shape of the vanes/paddles may vary for different embodiments. For example, the vanes/paddles may be flat plate-shaped, multi-chord flat plates, curved, or combinations thereof. The shape of the vanes/paddles chosen may be dictated by the size of the vanes/paddles and the materials used to make the vanes/paddles. Specifically, the vanes/paddles may be made from any of a variety of suitable materials, including, but not limited to, metal, aluminum, titanium, steel, carbon-fiber composite, fiber-glass composite, nylon composite, wood, plastic, compounds thereof, alloys thereof, composites thereof, or combinations thereof, for example.

In one embodiment, the body component is formed in a horizontal configuration and typically secured to an underside roof of the tunnel or other suitable roadway structure. Any suitable number of horizontal body components can be positioned within the tunnel as is needed, depending on the wants and/or needs of the user. Further, a plurality of devices can be attached horizontally to an existing concrete structure, such as a highway overpass. Further, the horizontally configured devices are adjustable for height as well as angle in order to safely clear vehicles that pass below and to interface most favorably with the airflow.

In one embodiment, the body component communicates with an electrical generator to harness the wind captured by the body component. Typically, the electrical generator is a variable-speed electrical generator but can be any suitable electrical generator as is known in the art. In another embodiment, the electrical generator is a cylindrical or spherical underground megawatt electrical generator. In yet another embodiment, multiple electrical generators can be utilized to communicate with the body components to store wind and generate renewable electricity. Specifically, the vanes/paddles and electrical generators are operatively connected, such that rotation of the vanes/paddles subsequently rotates the electrical generators.

In one embodiment, the electrical generator comprises a rotor. Typically, the electrical rotor of each variable-speed electrical generator captures residual motion of the wind to the maximum extent through flywheel effect, achieved partially through using light wind vanes/paddles with little inertia. Further, a shaft of the rotor extends along a rotational axis through the device. The rotor is adapted to rotate about the rotational axis during operation of the device. Hence, the shaft is preferably supported by some type of bearings (i.e., roller, hydraulic, etc.), which are preferably located at two ends of the shaft.

In one embodiment, the electrical generators used in the present invention may use magnetic bearings in lieu of traditional bearings, allowing them to be virtually free of maintenance, as shutting down traffic to lubricate bearings is inconvenient. Besides reducing maintenance, magnetic bearings also enhance efficiency. Also, some of the energy produced by the electrical generator can be siphoned off to power these bearings.

In one embodiment, a battery is connected to the electrical generator to store the energy produced. Specifically, the electrical generator charges the battery, which is storage for the energy, which powers the required outlet. Further, the electrical generator which is driven by a wind turbine which is driven by traffic wind could be built into a moveable unit or could be permanently built into the side of a tunnel or even part of a traffic light pole or light pole or other permanent structure.

In one embodiment, two electricity generators are coupled to the rotor shaft. each generator is rotationally coupled to each end of the rotor shaft. The first and second generators are preferably the same size (i.e., same weight, same size dimensionally, and same wattage output) to provide a balanced torque load on the rotor shaft and to provide a balanced structure, mechanically. An advantage of having two generators symmetrically located on each end of the rotor shaft is that the maximum stress exerted on the shaft may be cut in half while still producing the same amount of power as one larger generator (of double the power output) attached to only one end of the shaft. By reducing the stress on the shaft, the available choices of materials is broadened and the amount of material for the shaft (i.e., cost and/or weight of the shaft) needed structurally may be reduced.

In one embodiment, it should be noted that in this application, “wind” refers primarily to artificially-generated airflow; that is, the wind or high-speed airflow created by vehicular traffic, especially vehicular traffic moving through a tunnel. Thus, the device is driven by close proximity traffic in a highway system, such as an Interstate highway. Specifically, as vehicles, such as large trucks, tractor-trailers, or motor homes drive underneath highway overpasses, highway tunnels, etc., high-speed winds are created. The plurality of vanes/paddles in the body components receive the airflow as the vehicles pass. Typically, traffic generates a certain amount of wind firstly by displacing the air as a vehicle passes then secondly drawing the air which was displaced back, known as a vortex, to fill the gap which was displaced. The velocity of the wind is in direct relationship to the speed of the vehicle penetrating the air. Thus, it could be understood that each vehicle is able to effectively drive multiple generators installed alongside a tunnel.

In one embodiment, the plurality of vanes/paddles may turn in one or both directions. Also, vanes/paddles can preferably withstand sudden wind bursts of more than 300 mph, and the body component can capture energy from natural prevailing winds as much as possible.

In one embodiment, the body component comprises ducting. The use of ducting with the device will increase its efficiency. For example, ducting the wind speed at the vanes/paddles will increase the efficiency of the device via a Venturi or funnel effect.

In one embodiment, the traffic-driven wind generator device should be in close proximity to the tunnel and the roadway in order to harness the most energy. Also, the traffic-driven wind generator devices can be positioned, such that the devices capture energy from traffic going in one direction or both directions through the tunnel. Further, it should be noted that any number of generators may be used and in a serial configuration. In addition, any combination of body components positioned horizontally or vertically is also envisioned. In one embodiment, a plurality of devices are positioned in a cluster, with each body component comprising at least two electrical generators.

In one embodiment, the traffic-driven wind generator device comprises a mesh grill or other protective front component. The mesh grill is used to protect the device from road debris and insects, etc. The mesh grill would be positioned over an outwardly facing portion of the body component, to protect the plurality of vanes/paddles from collecting debris, dirt, insects, etc.

In use, at least one traffic-driven wind generator device is positioned on or near a tunnel or other roadway structure. Typically, multiple traffic-driven wind generator devices are positioned on or near the tunnel. As multiple vehicles pass through the tunnel on the roadway, the high-speed winds generated by the passing vehicles are captured by the vanes/paddles of the body component, causing the vanes/paddles to rotate. The rotation of the vanes/paddles subsequently rotates the electrical generators. Specifically, the electrical rotor of each variable-speed electrical generator captures residual motion of the wind to the maximum extent through flywheel effect, achieved partially through using light wind vanes/paddles with little inertia. The electrical generators then generate electricity. Any suitable number of device may be provided and in a serial configuration. Further, the device can be horizontally and/or vertically configured. Also, although the traffic-driven wind generator device is described with reference to a roadway tunnel, the devices may also be applied to other roadway structures as is known in the art (i.e., highway underpasses, trains, etc.).

In one embodiment, the wind energy captured and converted to electrical energy on highways can be utilized to power lights within the tunnel, as well as the surrounding roadways. Specifically, the wind which drives the turbine is harnessed from vehicle traffic on roads, bridges, and in tunnels located in especially remote areas, which require energy for lighting purposes or any other electrical energy requirement. Generally, bridges, tunnels, and other structures need lighting for safety purposes as well as road signs and road warning signs, all need lighting. In remote areas such lighting is often not possible due to where they are situated. Thus, the device provides a source of lighting inexpensively for roads and provides a means for alerting drivers of vehicles of impending dangers on roads and bridges and in tunnels and any other reason where lighting and or electricity is required.

In yet another embodiment, the wind energy captured and converted to electrical energy on highways can be utilized to power an underground heating system. The underground heating system would be utilized to melt snow and ice on the roadway and within the tunnel, as needed.

In addition, the wind energy captured and converted to electrical energy on highways can be sent to designated rest stops where it can be used to recharge electric or hybrid vehicles. Further, the device can be used to charge vehicle batteries by providing a specialized battery that allows the vehicle to replace the vehicle's battery cells with the recharged chemical used in batteries. The device can also replace power sources for cities in emergencies, replacing windmills to offer a more efficient and consistent power source. Additionally, the ability of the device could potentially be harnessed to supply several surrounding neighborhoods with electricity that could be stored in several megawatt generators, as needed.

In yet another embodiment, the traffic-driven wind generator device comprises a plurality of indicia.

In yet another embodiment, a method of generating electrical power via captured wind speed from vehicles is disclosed. The method includes the steps of providing a traffic-driven wind generator device comprising a body component configured as an upright cylinder with paddles on the outside to catch wind from vehicles passing by. The method also comprises positioning at least one body component in or around a roadway tunnel. Further, the method comprises capturing the wind from vehicles driving through the tunnels via the body component. The method also comprises redirecting the captured wind to power an electrical generator. Finally, the method comprises utilizing the electrical generator to power tunnel lights and an underground heating system to melt ice and snow on the road.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the traffic-driven wind generator device of the present invention showing the device in use to power lights in a tunnel in accordance with the disclosed architecture;

FIG. 2 illustrates a perspective view of one embodiment of the traffic-driven wind generator device of the present invention showing the wind turbines in accordance with the disclosed architecture;

FIG. 3 illustrates a perspective view of one embodiment of the traffic-driven wind generator device of the present invention showing the under-road heat generators in accordance with the disclosed architecture;

FIG. 4 illustrates a perspective view of one embodiment of the traffic-driven wind generator device of the present invention showing a conventional tunnel used with the device in accordance with the disclosed architecture;

FIG. 5 illustrates a perspective view of one embodiment of the traffic-driven wind generator device of the present invention in use in accordance with the disclosed architecture; and

FIG. 6 illustrates a flowchart showing the method of generating electrical power via captured wind speed from vehicles in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a traffic-driven wind generator device that provides users with an electrical power generator device for capturing, harnessing, and redirecting wind speed on automobiles to power underground megawatt electric generators. There is also a long-felt need in the art for a traffic-driven wind generator device that features cylinders installed within the tunnel that house the wind turbines. Further, there is a long-felt need in the art for a traffic-driven wind generator device that allows the wind turbines to rotate and generate power as vehicles pass through the tunnel. Moreover, there is a long-felt need in the art for a device that includes tunnel lights and underground heating systems that can melt snow and ice on the road when powered via the turbines. Further, there is a long-felt need in the art for a traffic-driven wind generator device that offers a way to generate renewable electricity to reduce the consumption of fossil fuels. Finally, there is a long-felt need in the art for a traffic-driven wind generator device that can replace power sources for cities in emergencies, replacing windmills.

The present invention, in one exemplary embodiment, is a novel traffic-driven wind generator device. The device captures, harnesses, and redirects wind speed from vehicles on highways to power cylindrical and spherical underground megawatt electrical generators. The traffic-driven wind generator device comprises a body component that is configured as an upright cylinder with paddles on the outside that will catch the wind from vehicles passing by. The body component can be embedded within the infrastructure of tunnels to rotate the wind turbines and generate renewable energy. The device may vary in design while providing users with generated electricity. The present invention also includes a novel method of generating electrical power via captured wind speed from vehicles. The method includes the steps of providing a traffic-driven wind generator device comprising a body component configured as an upright cylinder with paddles on the outside to catch wind from vehicles passing by. The method also comprises positioning at least one body component in or around a roadway tunnel. Further, the method comprises capturing the wind from vehicles driving through the tunnels via the body component. The method also comprises redirecting the captured wind to power an electrical generator. Finally, the method comprises utilizing the electrical generator to power tunnel lights and an underground heating system to melt ice and snow on the road.

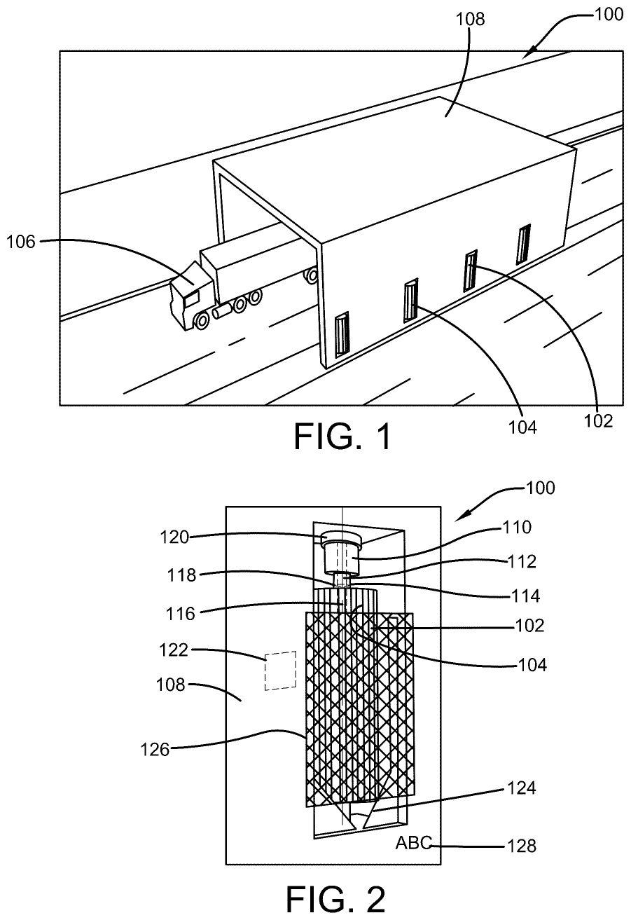

Referring initially to the drawings, FIG. 1 illustrates a perspective view of one embodiment of the traffic-driven wind generator device 100 of the present invention. In the present embodiment, the traffic-driven wind generator device 100 is an improved traffic-driven wind generator device 100 that provides a user with a device for capturing, harnessing, and redirecting wind speed from vehicles 106 to power electrical generators 110. Specifically, the traffic-driven wind generator device 100 comprises a body component 102 configured as an upright cylinder with paddles 104 on the outside that will catch wind from vehicles 106 passing through a tunnel 108 or other roadway structure. The body component 102 can be embedded within the infrastructure of the tunnels 108 to rotate the wind turbines (i.e., paddles 104) and generate renewable energy. The device 100 may vary in design while providing users with generated electricity.

Generally, the traffic-driven wind generator device 100 is a wind-capturing, harnessing, and redirecting electrical generator device 100 comprising a plurality of generators 110 that are driven by wind created by traffic passing at high speeds through a tunnel 108 or other roadway structure. The device 100 uses horizontally or vertically-mounted paddles 104 to capture the wind and produce electrical energy. Accordingly, a plurality of traffic-driven wind generator devices 100 may be mounted in close proximity to vehicular passageways (i.e., highway overpasses, tunnels 108, and/or train rails, etc.) to drive an electrical power generator 110 to generate power. The traffic-driven wind generator device 100 can also be used with a train system, such as a high-speed train system, including “bullet” or MAGLEV trains, which provide a high-speed buffeting force.

Further, the traffic-driven wind generator device 100 comprises a vertically-mounted wind generator. Specifically, the device 100 comprises a body component 102 that is configured as an upright cylinder with a plurality of paddles 104 on the outside that act to catch wind from vehicles 106 driving past. The body component 102 can be any suitable size and shape as is known in the art. Any suitable number of paddles 104 can be utilized within each body component 102. The paddles 104 can be any suitable shape and size and are energy-capturing vanes. Further, the vertical configuration of the body component 102 can be integrated within the walls of the tunnel 108 or any other suitable position as is known in the art. Further, any suitable number of vertical body components 102 can be positioned within the tunnel 108 as is needed, depending on the wants and/or needs of the user.

Additionally, in one embodiment, the body component 102 is formed in a horizontal configuration and typically secured to an underside roof 134 of the tunnel 108 or other suitable roadway structure. Any suitable number of horizontal body components 102 can be positioned within the tunnel 108 as is needed, depending on the wants and/or needs of the user. Further, a plurality of devices 100 can be attached horizontally to an existing concrete structure, such as a highway overpass. Further, the horizontally configured devices 100 are adjustable for height as well as angle in order to safely clear vehicles 106 that pass below and to interface most favorably with the airflow.

Furthermore, it should be noted that in this application, “wind” refers primarily to artificially-generated airflow; that is, the wind or high-speed airflow created by vehicular traffic, especially vehicular traffic moving through a tunnel 108. Thus, the device 100 is driven by close proximity traffic in a highway system, such as an Interstate highway. Specifically, as vehicles 106, such as large trucks, tractor-trailers, or motor homes drive underneath highway overpasses, highway tunnels, etc., high-speed winds are created. The plurality of vanes/paddles 104 in the body components 102 receive the airflow as the vehicles 106 pass. Typically, traffic generates a certain amount of wind firstly by displacing the air as a vehicle 106 passes then secondly drawing the air which was displaced back, known as a vortex, to fill the gap which was displaced. The velocity of the wind is in direct relationship to the speed of the vehicle 106 penetrating the air. Thus, it could be understood that each vehicle 106 is able to effectively drive multiple generators 110 installed alongside a tunnel 108.

Additionally, the traffic-driven wind generator device 100 should be in close proximity to the tunnel 108 and the roadway in order to harness the most energy. Also, the traffic-driven wind generator devices 100 can be positioned, such that the devices 100 capture energy from traffic going in one direction or both directions through the tunnel 108. Further, it should be noted that any number of generators 110 may be used and in a serial configuration. In addition, any combination of body components 102 positioned horizontally or vertically is also envisioned. In one embodiment, a plurality of devices 100 are positioned in a cluster, with each body component 102 comprising at least two electrical generators 110.

As shown in FIG. 2, any suitable number of vanes/paddles 104 can be utilized as is known in the art. Further, the shape of the vanes/paddles 104 may vary for different embodiments. For example, the vanes/paddles 104 may be flat plate-shaped, multi-chord flat plates, curved, or combinations thereof. The shape of the vanes/paddles 104 chosen may be dictated by the size of the vanes/paddles 104 and the materials used to make the vanes/paddles 104. Specifically, the vanes/paddles 104 may be made from any of a variety of suitable materials, including, but not limited to, metal, aluminum, titanium, steel, carbon-fiber composite, fiber-glass composite, nylon composite, wood, plastic, compounds thereof, alloys thereof, composites thereof, or combinations thereof, for example.

Typically, the plurality of vanes/paddles 104 may turn in one or both directions. Also, vanes/paddles 104 can preferably withstand sudden wind bursts of more than 300 mph, and the body component 102 can capture energy from natural prevailing winds as much as possible.

Further, the body component 102 communicates with an electrical generator 110 to harness the wind captured by the body component 102. Typically, the electrical generator 110 is a variable-speed electrical generator but can be any suitable electrical generator 110 as is known in the art. In another embodiment, the electrical generator 110 is a cylindrical or spherical underground megawatt electrical generator. In yet another embodiment, multiple electrical generators 110 can be utilized to communicate with the body components 102 to store wind and generate renewable electricity. Specifically, the vanes/paddles 104 and electrical generators 110 are operatively connected, such that rotation of the vanes/paddles 104 subsequently rotates the electrical generators 110.

Additionally, the electrical generator 110 comprises a rotor 112. Typically, the electrical rotor 112 of each variable-speed electrical generator 110 captures residual motion of the wind to the maximum extent through flywheel effect, achieved partially through using light wind vanes/paddles 104 with little inertia. Further, a shaft 114 of the rotor 112 extends along a rotational axis 116 through the device 100. The rotor 112 is adapted to rotate about the rotational axis 116 during operation of the device 100. Hence, the shaft 114 is preferably supported by some type of bearings 118 (i.e., roller, hydraulic, etc.), which are preferably located at two ends of the shaft 114.

Furthermore, the electrical generators 110 used in the present invention may use magnetic bearings 120 in lieu of traditional bearings 118, allowing them to be virtually free of maintenance, as shutting down traffic to lubricate bearings 118 is inconvenient. Besides reducing maintenance, magnetic bearings 120 also enhance efficiency. Also, some of the energy produced by the electrical generator 110 can be siphoned off to power these bearings 120.

Further, a battery 122 is connected to the electrical generator 110 to store the energy produced. Specifically, the electrical generator 110 charges the battery 122, which is storage for the energy, which powers the required outlet. Further, the electrical generator 110 which is driven by a wind turbine which is driven by traffic wind could be built into a moveable unit or could be permanently built into the side of a tunnel 108 or even part of a traffic light pole or light pole or other permanent structure.

In one embodiment, two electricity generators 110 are coupled to the rotor shaft 114, wherein each generator 110 is rotationally coupled to each end of the rotor shaft 114. The first and second generators 110 are preferably the same size (i.e., same weight, same size dimensionally, and same wattage output) to provide a balanced torque load on the rotor shaft 114 and to provide a balanced structure, mechanically. An advantage of having two generators 110 symmetrically located on each end of the rotor shaft 114 is that the maximum stress exerted on the shaft 114 may be cut in half while still producing the same amount of power as one larger generator 110 (double the power output) attached to only one end of the shaft 114. By reducing the stress on the shaft 114, the available choices of materials is broadened and the amount of material for the shaft 114 (i.e., cost and/or weight of the shaft 114) needed structurally may be reduced.

In another embodiment, the body component 102 comprises ducting 124. The use of ducting 124 with the device 100 will increase its efficiency. For example, ducting the wind speed at the vanes/paddles 104 will increase the efficiency of the device 100 via a Venturi or funnel effect.

In one embodiment, the traffic-driven wind generator device 100 comprises a mesh grill 126 or other protective front component. The mesh grill 126 is used to protect the device 100 from road debris and insects, etc. The mesh grill 126 would be positioned over an outwardly facing portion of the body component 102, to protect the plurality of vanes/paddles 104 from collecting debris, dirt, insects, etc.

In yet another embodiment, the traffic-driven wind generator device 100 comprises a plurality of indicia 128. The body component 102 of the device 100 may include advertising, a trademark, or other letters, designs, or characters, printed, painted, stamped, or integrated into the body component 102, or any other indicia 128 as is known in the art. Specifically, any suitable indicia 128 as is known in the art can be included, such as, but not limited to, patterns, logos, emblems, images, symbols, designs, letters, words, characters, animals, advertisements, brands, etc., that may or may not be tunnel, wind generator, or brand related.

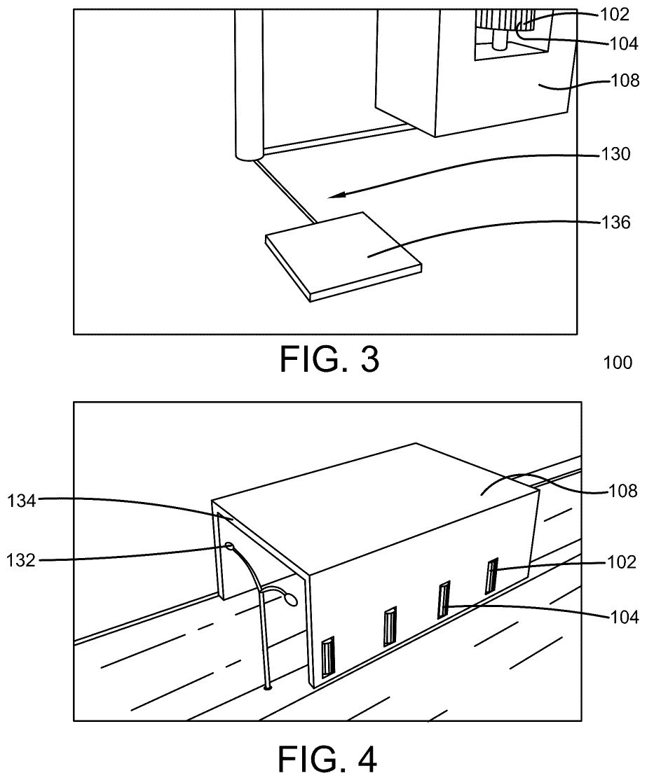

As shown in FIG. 3, the wind energy captured and converted to electrical energy on highways can be utilized to power an underground heating system 130. The underground heating system 130 would be utilized to melt snow and ice on the roadway and within the tunnel 108, as needed. The heating system 130 would comprise under-road heat generators 136 that would be powered by the traffic-driven wind generator device 100. Any suitable number of heat generators 136 can be utilized as is known in the art. Further, the heat generators 136 can be positioned near a mouth of the tunnel 108 or embedded throughout the tunnel 108, as needed.

In addition, the wind energy captured and converted to electrical energy on highways can be sent to designated rest stops where it can be used to recharge electric or hybrid vehicles. Further, the device 100 can be used to charge vehicle batteries 122 by providing a specialized battery that allows the vehicle 106 to replace the vehicle's battery cells with the recharged chemical used in batteries. The device 100 can also replace power sources for cities in emergencies, replacing windmills to offer a more efficient and consistent power source. Additionally, the ability of the device 100 could potentially be harnessed to supply several surrounding neighborhoods with electricity that could be stored in several megawatt generators, as needed.

As shown in FIG. 4, in one embodiment, the wind energy captured and converted to electrical energy on highways can be utilized to power lights 132 within the tunnel 108, as well as the surrounding roadways. Specifically, the wind which drives the turbine is harnessed from vehicle traffic on roads, bridges, and in tunnels 108 located in especially remote areas, which require energy for lighting purposes or any other electrical energy requirement. Generally, bridges, tunnels 108, and other structures need lighting for safety purposes as well as road signs and road warning signs, all need lighting. In remote areas such lighting is often not possible due to where they are situated. Thus, the device 100 provides a source of lighting inexpensively for roads and provides a means for alerting drivers of vehicles 106 of impending dangers on roads and bridges and in tunnels 108 and any other reason where lighting and or electricity is required.

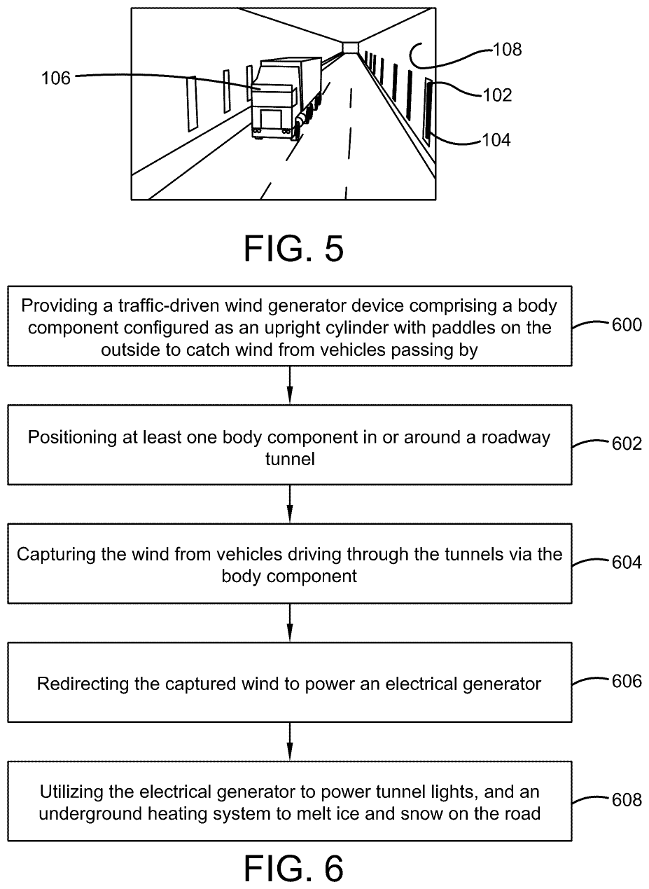

As shown in FIG. 5, in use, at least one traffic-driven wind generator device 100 is positioned on or near a tunnel 108 or other roadway structure. Typically, multiple traffic-driven wind generator devices 100 are positioned on or near the tunnel 108. As multiple vehicles 106 pass through the tunnel 108 on the roadway, the high-speed winds generated by the passing vehicles 106 are captured by the vanes/paddles 104 of the body component 102, causing the vanes/paddles 104 to rotate. Rotation of the vanes/paddles 104 subsequently rotates the electrical generators 110. Specifically, the electrical rotor 112 of each variable-speed electrical generator 110 captures residual motion of the wind to the maximum extent through flywheel effect, achieved partially through using light wind vanes/paddles 104 with little inertia. The electrical generators 110 then generate electricity. Any suitable number of devices 100 may be provided and in a serial configuration. Further, the device 100 can be horizontally and/or vertically configured. Also, although the traffic-driven wind generator device 100 is described with reference to a roadway tunnel 108, the devices 100 may also be applied to other roadway structures as is known in the art (i.e., highway underpasses, trains, etc.).

FIG. 6 illustrates a flowchart of the method of generating electrical power via captured wind speed from vehicles. The method includes the steps of at 600, providing a traffic-driven wind generator device comprising a body component configured as an upright cylinder with paddles on the outside to catch wind from vehicles passing by. The method also comprises at 602, positioning at least one body component in or around a roadway tunnel. Further, the method comprises at 604, capturing the wind from vehicles driving through the tunnels via the body component. The method also comprises at 606, redirecting the captured wind to power an electrical generator. Finally, the method comprises at 608, utilizing the electrical generator to power tunnel lights and an underground heating system to melt ice and snow on the road.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “traffic-driven wind generator device”, “traffic-driven device”, “wind generator device”, and “device” are interchangeable and refer to the traffic-driven wind generator device 100 of the present invention.

Notwithstanding the foregoing, the traffic-driven wind generator device 100 of the present invention can be of any suitable size and configuration as is known in the art without affecting the overall concept of the invention, provided that it accomplishes the above-stated objectives. One of ordinary skill in the art will appreciate that the traffic-driven wind generator device 100 as shown in FIGS. 1-6 is for illustrative purposes only, and that many other sizes and shapes of the traffic-driven wind generator device 100 are well within the scope of the present disclosure. Although the dimensions of the traffic-driven wind generator device 100 are important design parameters for user convenience, the traffic-driven wind generator device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A traffic-driven wind generator device that provides a user with a device for capturing, harnessing, and redirecting wind speed from vehicles to power electrical generators, the traffic-driven wind generator device comprising:
a body component; and
an electrical generator;
wherein the body component is configured as an upright cylinder with a plurality of paddles that rotate for catching wind;
wherein the rotation of the plurality of paddles subsequently rotates the electrical generator to generate power; and
wherein the body component is integrated into a tunnel, such that wind speed from passing vehicles is captured by the plurality of paddles to produce electricity;
wherein the plurality of paddles are flat-plate shaped carbon-fiber composite paddles; and
wherein the electrical generator is a variable-speed spherical underground electrical generator.

2. The traffic-driven wind generator device of claim 1, wherein the body component is a vertically-mounted wind generator.

3. The traffic-driven wind generator device of claim 2, wherein the vertically-mounted wind generator is integrated into walls of the tunnel.

4. The traffic-driven wind generator device of claim 1, wherein the body component is a horizontally-mounted wind generator.

5. The traffic-driven wind generator device of claim 4, wherein the horizontally-mounted wind generator is secured to an underside roof of the tunnel.

6. The traffic-driven wind generator device of claim 1, wherein wind refers primarily to artificially-generated airflow created by vehicular traffic moving through a tunnel.

7. The traffic-driven wind generator device of claim 6, wherein multiple body components can be placed on either side of the tunnel, such that the body components capture energy from traffic going in both directions through the tunnel.

8. The traffic-driven wind generator device of claim 7, wherein the plurality of paddles turn in both directions.

9. (canceled)

10. The traffic-driven wind generator device of claim 8, wherein the electrical generator comprises a rotor and a shaft which extends along a rotational axis through the body component, the rotor is adapted to rotate about the rotational axis during operation of the traffic-driven wind generator device.

11. The traffic-driven wind generator device of claim 10, wherein a battery is connected to the electrical generator to store the energy produced.

12. The traffic-driven wind generator device of claim 11, wherein two electricity generators are coupled to the shaft to provide a balanced torque load on the shaft and to provide a balanced structure, mechanically.

13. A traffic-driven wind generator device that provides a user with a device for capturing, harnessing, and redirecting wind speed from vehicles to power electrical generators, the traffic-driven wind generator device comprising:
a body component configured as an upright cylinder with a plurality of paddles that rotate for catching wind; and
an electrical generator comprising a rotor and a shaft which extends along a rotational axis through the body component, the rotor is adapted to rotate about the rotational axis during operation of the traffic-driven wind generator device; and
wherein the rotation of the plurality of paddles subsequently rotates the electrical generator to generate power;
wherein the body component is integrated into a tunnel, such that wind speed from passing vehicles is captured by the plurality of paddles to produce electricity;
wherein a battery is connected to the electrical generator to store the electricity produced;
wherein wind refers primarily to artificially-generated airflow created by vehicular traffic moving through a tunnel; and
wherein multiple body components can be placed on either side of the tunnel, such that the body components capture energy from traffic going in both directions through the tunnel;
wherein the plurality of paddles are multi-chord flat-plate shaped fiber-glass composite paddles; and
wherein the electrical generator is a movable electrical generator.

14. The traffic-driven wind generator device of claim 13, wherein two electricity generators are coupled to the shaft to provide a balanced torque load on the shaft and to provide a balanced structure, mechanically.

15. The traffic-driven wind generator device of claim 13, wherein the body component comprises ducting to increase efficiency.

16. The traffic-driven wind generator device of claim 13, wherein the body component comprises a mesh grill to protect the plurality of paddles from road debris and insects.

17. The traffic-driven wind generator device of claim 13 further comprising a plurality of indicia.

18. The traffic-driven wind generator device of claim 13, wherein the wind energy captured and converted to electrical energy is utilized to power an underground heating system comprising under-road heat generators.

19. The traffic-driven wind generator device of claim 13, wherein the wind energy captured and converted to electrical energy is utilized to power lights within the tunnel.

20. A method of generating electrical power via captured wind speed from vehicles, the method comprising the following steps:
providing a traffic-driven wind generator device comprising a body component configured as an upright cylinder with paddles on the outside to catch wind from vehicles passing by; positioning at least one body component in or around a roadway tunnel;
capturing the wind from vehicles driving through the tunnels via the body component;
redirecting the captured wind to power an electrical generator; and
utilizing the electrical generator to power tunnel lights and an underground heating system to melt ice and snow on the road;
moving the electrical generator to provide a remote power source for charging a vehicle battery; and
wherein the plurality of paddles are a combination of curved and multi-chord flat-plate shaped nylon composite paddles.
